(19) United States
(12) Patent Application Publication
(10) Pub. No.: US 2019/0346657 A1
(43) Pub. Date: Nov. 14, 2019

(54) LENS BARREL

(71) Applicant: OLYMPUS CORPORATION, Tokyo (JP)

(72) Inventors: Osamu HAYASHI, Tokyo (JP); Kazunori YUGE, Tokorozawa-shi (JP); Takaaki UE, Tokyo (JP); Satoru YASUTOMI, Tokyo (JP); Tetsuya TAKAGI, Tokyo (JP); Naoki MATSUMOTO, Tokyo (JP); Takahiro KOYAMA, Tokyo (JP)

(73) Assignee: OLYMPUS CORPORATION, Tokyo (JP)

(21) Appl. No.: 16/290,888

(22) Filed: Mar. 2, 2019

(30) Foreign Application Priority Data
May 14, 2018 (JP) 2018-093034

(51) Int. Cl. G02B 7/10; G02B 7/02; G03B 17/12; G02B 15/14

(52) U.S. Cl. CPC G02B 7/10; G02B 15/14; G03B 17/12; G02B 7/023

(57) ABSTRACT

A lens barrel in which an air flow path that causes an external space and an internal space to communicate is formed includes an aperture unit disposed in the internal space and configured to rotate a plurality of vane members within a predetermined range to form a predetermined opening, an optical unit disposed in the internal space and located on an object side with respect to the aperture unit, and a through-hole formed in the aperture unit and communicating with the internal space. When at least one of the optical unit and the aperture unit moves in an optical axis direction, the lens barrel discharges, through the air flow path and the through-hole, air in the internal space and static electricity charged in the plurality of vane members included in the air in the internal space.

### CROSS REFERENCE TO RELATED APPLICATION

This application claims the benefit of Japanese Application No. 2018-093034 filed in Japan on May 14, 2018, the contents of which are incorporated herein by this reference.

### BACKGROUND OF THE INVENTION

### 1. Field of the Invention

The present invention herein relates generally to a lens barrel including a light amount adjusting device (an aperture unit) for adjusting an amount of light, which passes through an optical system, by driving a plurality of vane members.

### 2. Description of Related Art

In one lens barrel in the past provided in an image pickup apparatus or the like and including an image pickup optical system, a light amount adjusting device (a so-called aperture unit) for adjusting an amount of light passing through an image pickup optical system is disposed on an optical path of the image pickup optical system.

In such a light amount adjusting device in the past of this type, a respective plurality of vane members, which are disposed around an optical axis of an optical system in a faun in which parts of the vane members are superimposed one on top of another, are rotated around supporting shafts of the respective vane members to form a desired opening (referred to as an aperture opening).

As a configuration of the plurality of vane members themselves, in general, for example, the plurality of vane members are formed in a thin plate shape using a resin material or the like. Therefore, when the plurality of vane members are driven to form the desired aperture opening, the vane members adjacent to one another slide with one another. Consequently, static electricity is likely to be generated among the plurality of vane members.

### SUMMARY OF THE INVENTION

A lens barrel according to an aspect of the present invention is a lens barrel in which an air flow path that causes an external space and an internal space to communicate is formed, the lens barrel including: an aperture unit disposed in the internal space and configured to rotate a plurality of vane members within a predetermined range to form a predetermined opening; an optical unit disposed in the internal space and located on an object side with respect to the aperture unit; and at least one through-hole formed in the aperture unit and communicating with the internal space. When at least one of the optical unit and the aperture unit moves in an optical axis direction, the lens barrel discharges, through the air flow path and the through-hole, air in the internal space and static electricity charged in the plurality of vane members included in the air in the internal space.

Benefits of the present invention will become clearer from the following detailed explanation.

### BRIEF DESCRIPTION OF THE DRAWINGS

FIG. 1 is a longitudinal sectional view showing a configuration of a lens barrel in an embodiment of the present invention and showing a state in which the lens barrel is cut along a surface including an optical axis O (a shortest focal length state (at a wide angle end));

FIG. 2 is a main part enlarged sectional view enlarging and showing a portion indicated by an arrow sign [2] in FIG. 1;

FIG. 3 is a longitudinal sectional view showing the configuration of the lens barrel in the embodiment of the present invention and showing a state in which the lens barrel is cut along the surface including the optical axis O (a longest focal length state (at a telephoto end));

FIG. 4 is a main part enlarged sectional view enlarging and showing a portion indicated by an arrow sign [4] in FIG. 3;

FIG. 5 is an exterior perspective view of a light amount adjusting device applied to the lens barrel in the embodiment of the present invention;

FIG. 6 is an exterior perspective view showing a cut surface cut along a plane indicated by a sign [6] in FIG. 5;

FIG. 7 is an exploded perspective view of the light amount adjusting device shown in FIG. 5;

FIG. 8 is a trihedral figure of a vane driving member in the light amount adjusting device shown in FIG. 5;

FIG. 9 is a trihedral figure of a lid member in the light amount adjusting device shown in FIG. 5;

FIG. 10 is a sectional view (a sectional view taken along a [10]-[10] line in FIG. 11) showing a state in which the light amount adjusting device shown in FIG. 5 is assembled to a third lens group holding cylinder;

FIG. 11 is a plan view (a rear view) viewed from an arrow [11] direction in FIG. 10; and

FIG. 12 is a plan view (a front view) viewed from an arrow [12] direction in FIG. 10.

### DETAILED DESCRIPTION OF THE PREFERRED EMBODIMENTS

The present invention is explained below according to an embodiment shown in the figures. Respective drawings used for the following explanation schematically show components. In order to show the respective components in sizes recognizable on the drawings, dimensional relations, scales, and the like of respective members are sometimes differentiated for each of the components and shown. Therefore, the present invention is not limited only to forms shown in the figures concerning the numbers of the respective components shapes of the respective components, ratios of sizes of the respective components, relative positional relations among the respective components, and the like, described in the respective drawings.

An embodiment explained below illustrates a lens barrel provided in an image pickup apparatus or the like, including a light amount adjusting device, which is an aperture unit, and including an image pickup optical system. That is, the present embodiment specifically illustrates a lens barrel attached to an image pickup apparatus such as a still camera or a video camera.

In the present embodiment, an interchangeable lens barrel in a so-called lens interchangeable image pickup apparatus of a form in which the lens barrel is detachably attachable to an image pickup apparatus main body is illustrated.

However, a form of a lens barrel to which the present invention is applicable is not limited to the interchangeable lens barrel. For example, the present invention can be applied in the same manner to a lens barrel in a so-called lens integrated image pickup apparatus of a form in which the lens barrel is integrally fixed to an image pickup apparatus main body.

Note that in the explanation of the present embodiment, an optical axis of an optical system is represented by a sign O. In a direction along the optical axis O, a surface present on a side on which a light beam is made incident is referred to as front surface of the lens barrel and a surface facing the front surface and present on a side from which the light beam is emitted is referred to as back surface of the lens barrel.

### Embodiment

First, a schematic configuration of a lens barrel in an embodiment of the present invention is briefly explained.

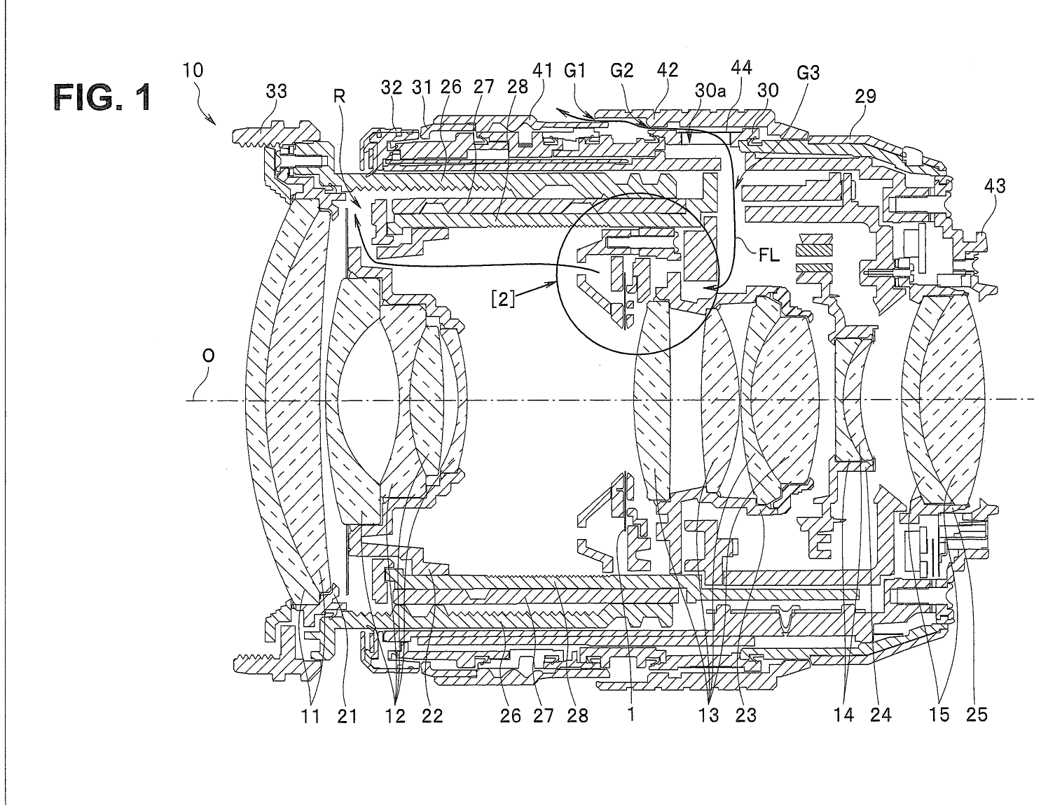

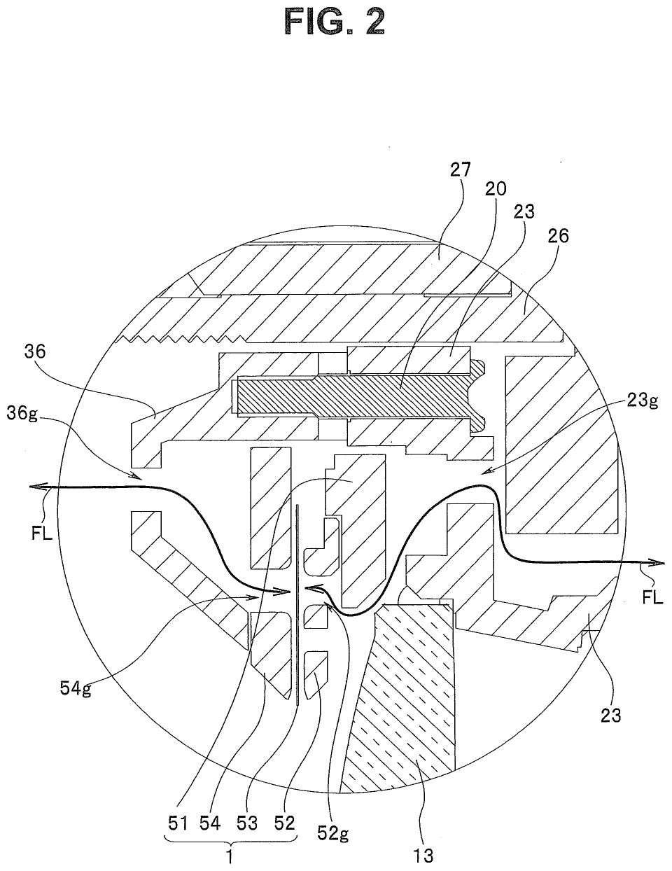

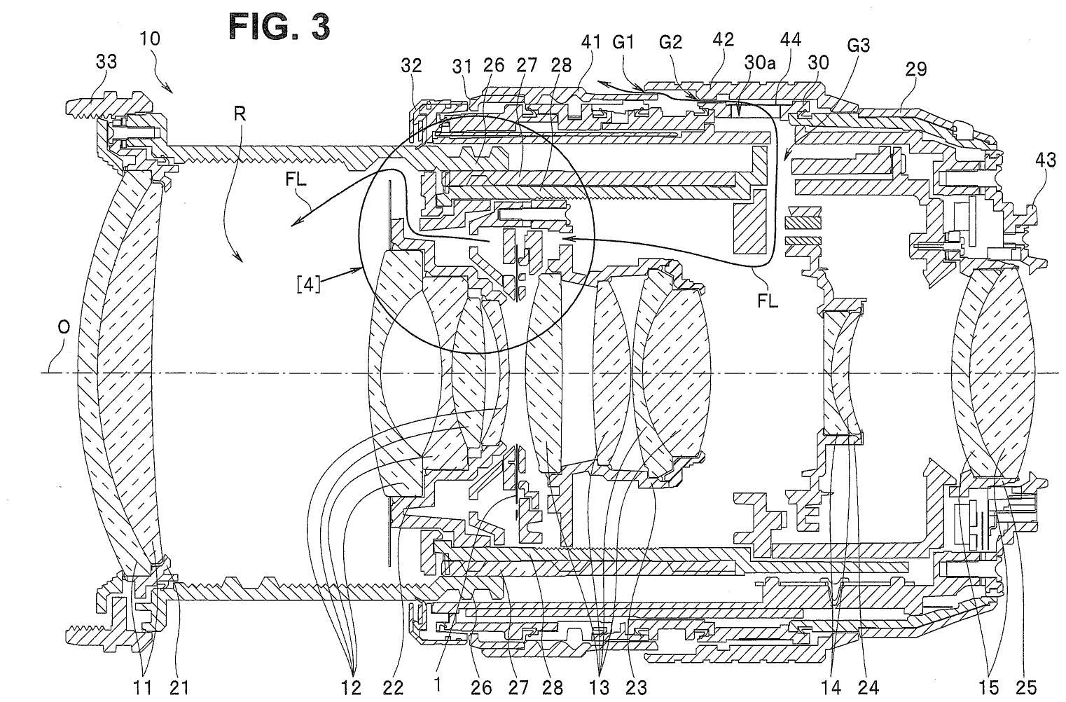

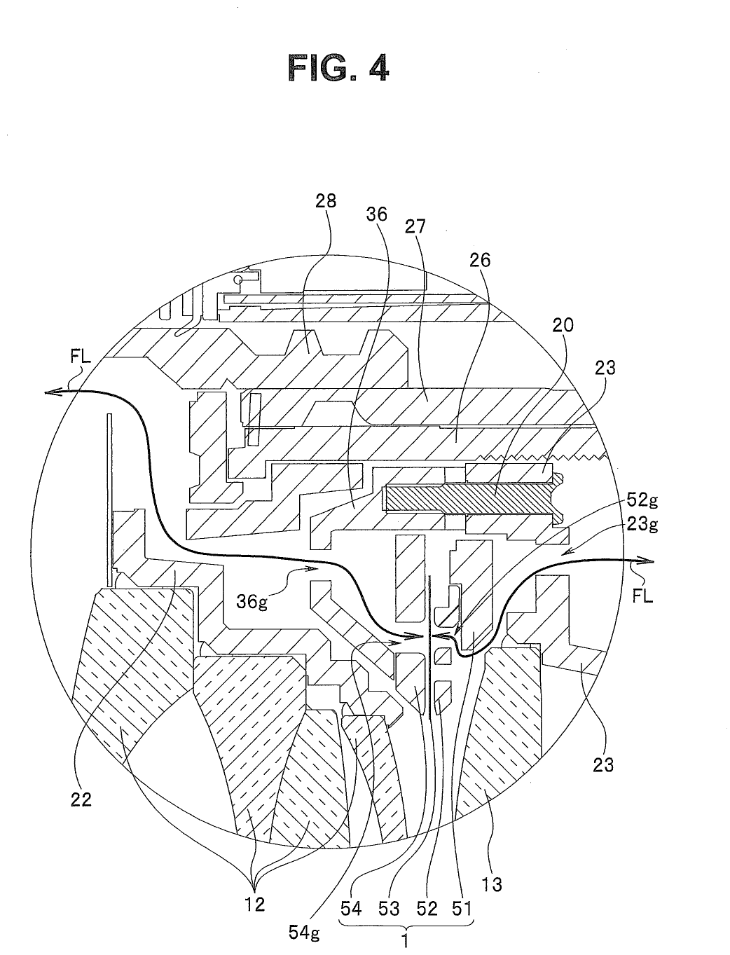

FIGS. 1 and 3 are longitudinal sectional views showing a configuration of the lens barrel in the embodiment of the present invention and showing a state in which the lens barrel is cut along a surface including the optical axis O. FIG. 1 shows a state of the lens barrel in the present embodiment at a time when the lens barrel is in a shortest focal length state (at a wide angle end) among focal lengths that can be set by the lens barrel. FIG. 3 shows a state of the lens barrel in the present embodiment at a time when the lens barrel is in a longest focal length state (at a telephoto end) among the focal lengths that can be set by the lens barrel. FIGS. 2 and 4 are main part enlarged sectional views enlarging and showing portions indicated by arrow signs [2] and [4] in FIGS. 1 and 3.

As shown in FIGS. 1 and 3, a lens barrel 10 in the embodiment of the present invention includes a predetermined mount section 43 in a rear end part such that the lens barrel 10 can be detachably disposed on a front surface of a not-shown image pickup apparatus. That is, the lens barrel illustrated in the present embodiment is shown as the lens barrel 10 of an interchangeable type configured to be detachably attachable to the image pickup apparatus (not shown in FIGS. 1 and 3).

Further, as illustration of the lens barrel 10 in the present embodiment, in FIGS. 1 and 3, a zoom lens barrel is configured such that the entire length of the lens barrel extends and contracts according to magnification operation (zooming operation).

The lens barrel 10 includes, as shown in FIGS. 1 and 3, a light amount adjusting device 1, which is an aperture unit, an image pickup optical system (the first to fifth lens groups 11 to 15), a plurality of lens group holding cylinders (21 to 25), a zoom mechanism (a movable cylinder 26, a cam cylinder 27, and an inner fixed cylinder 28), an exterior member (29 to 33), a plurality of operation members (a focus ring 41 and a zoom ring 42), a mount section 43, and an air permeable sheet 44.

The image pickup optical system (the first to fifth lens groups 11 to 15) is configured by a plurality of optical lenses. The image pickup optical system is a component unit configured to condense a light beam from an object present in front of the image pickup optical system, form an optical image of the object, and form an image of the object on a predetermined image forming surface. In the present embodiment, an example is shown in which the image pickup optical system includes five lens groups configured by pluralities of optical lenses.

That is, the image pickup optical system in the lens barrel 10 includes, in order from a front surface side, a first lens group 11, a second lens group 12, a third lens group 13, a fourth lens group 14, and a fifth lens group 15. The image pickup optical system is disposed along the optical axis O.

The first lens group 11 is held by a first lens group holding cylinder 21. The first lens group holding cylinder 21 is fixed to a distal end portion of a movable cylinder 26, which is a movable member. The first lens group holding cylinder 21 receives predetermined zooming operation, advances and retracts in the direction along the optical axis O together with the movable cylinder 26, and contributes to a zooming motion. A unit configured by the first lens group 11, the first lens group holding cylinder 21, and the movable cylinder 26 is referred to as first optical unit.

The second lens group 12 is held by a second lens group holding cylinder 22. The second lens group holding cylinder 22 is fixed to an inner fixed cylinder 28 explained below. The second lens group 12 held by the second lens group holding cylinder 22 also contributes to the zooming motion. A unit configured by the second lens group 12 and the second lens group holding cylinder 22 is referred to as second optical unit. The second optical unit is disposed in an internal space of the lens barrel 10.

The third lens group 13 is held by a third lens group holding cylinder 23. The third lens group holding cylinder 23 is fixed to a not-shown inner movable cylinder. The third lens group holding cylinder 23 receives the predetermined zooming operation, advances and retracts in the direction along the optical axis O together with the inner movable cylinder, and contributes to the zooming motion. A unit configured by the third lens group 13 and the third lens group holding cylinder 23 is referred to as third optical unit.

Note that as explained below, in the third lens group holding cylinder 23, the light amount adjusting device 1 (the aperture unit) is integrally attached to a position close to the object. That is, the light amount adjusting device 1 is disposed in a space between the second optical unit and the third optical unit. The second optical unit is located on the object side with respect to the light amount adjusting device 1 (the aperture unit).

The fourth lens group 14 is held by a fourth lens group holding cylinder 24. The fourth lens group holding cylinder 24 is fixed to a not-shown focusing mechanism. The fourth lens group holding cylinder 24 receives predetermined focusing operation, cooperates with the focusing mechanism, advances and retracts in the direction along the optical axis O, and contributes to a focusing motion.

The fifth lens group 15 is held by the fifth lens group holding cylinder 25. The fifth lens group holding cylinder 25 is fixed to a rear end portion of a fixed cylinder 29 of exterior members explained below.

The zoom mechanism is a mechanism unit configured to move the lens group holding cylinders (22 and 23), which are a part of the plurality of lens group holding cylinders, in the direction along the optical axis O. The zoom mechanism is configured by, for example, the movable cylinder 26, the cam cylinder 27, the inner fixed cylinder 28, and the zoom ring 42 among the plurality of operation members.

Concerning a detailed configuration of the zoom mechanism, it is assumed that the same zoom mechanism as a mechanism adopted in a general zoom lens in the past is applied. Explanation of the detailed configuration of the zoom mechanism is omitted. For example, when a user performs operation for rotating the zoom ring 42 around the optical axis O, the zoom mechanism on an inside interlocks with the operation. The cam cylinder 27 rotates around the optical axis O on an outer circumferential surface of the inner fixed cylinder 28. Consequently, the movable cylinder 26 moves in the direction along the optical axis O. The second lens group holding cylinder 22 and the third lens group holding cylinder 23 move in the direction along the optical axis O as appropriate.

The exterior member (29 to 33) is a cylindrical component member configured to cover an outer surface of the lens barrel 10. As the plurality of operation members, for example, the focus ring 41 and the zoom ring 42 are provided. The focus ring 41 and the zoom ring 42 are disposed rotatably around the optical axis O. The focus ring 41 interlocks with a not-shown focus mechanism. The zoom ring 42 interlocks with the not-shown zoom mechanism as explained above. The focus ring 41 and the zoom ring 42 respectively perform predetermined motions.

The mount section 43 is a coupling member for coupling and fixing the lens barrel on a front surface of a not-shown image pickup apparatus. As the mount section 43, a mount section of a form applied in a general lens interchangeable image pickup apparatus, for example, a coupling member of a bayonet type is applied.

In the lens barrel 10, the focus ring 41 and the zoom ring 42 are disposed to partially overlap each other in a circumferential direction. In this case, a gap G1 is formed between the focus ring 41 and the zoom ring 42. The gap G1 has a dimension enough for allowing air to flow in and out between an outside and an inside of the lens barrel 10.

A gap G2 having a predetermined dimension enough for allowing the air to flow in and out between the outside and the inside of the lens barrel 10 is also formed between the zoom ring 42 and an exterior member 30 configured to rotatably hold the zoom ring 42.

A plurality of hole sections 30a piercing through the exterior member 30 in a radial direction are formed in the exterior member 30. The hole sections 30a configure a part of an air flow path for sucking the air flowing in through the gap G1 and the gap G2 into the inside of the lens barrel 10 and discharging the air on the inside to the outside. That is, the gaps G1 and G2 to the hole sections 30a form an air flow path for allowing circulation of the air between an external space and an internal space.

Outer surface sides of the hole sections 30a are covered by the air permeable sheet 44. The air permeable sheet 44 is configured by a net having fine meshes made of synthetic resin such as polyester. The air permeable sheet 44 is made of, for example, a material having high water repellency. Alternatively, surface treatment for improving water repellency is applied to the air permeable sheet 44. The air permeable sheet 44 allows the air to pass and prevents dust and liquid droplets reaching the hole sections 30a from the exterior space of the lens barrel 10 through the gaps G1 and G2 from intruding into the internal space of the lens barrel 10 through the hole sections 30a.

In this way, the lens barrel 10 illustrated in the present embodiment is a lens barrel of a form in which the air flow path (the gaps G1 and G2 and the hole sections 30a) for causing the external space and the internal space to communicate is formed.

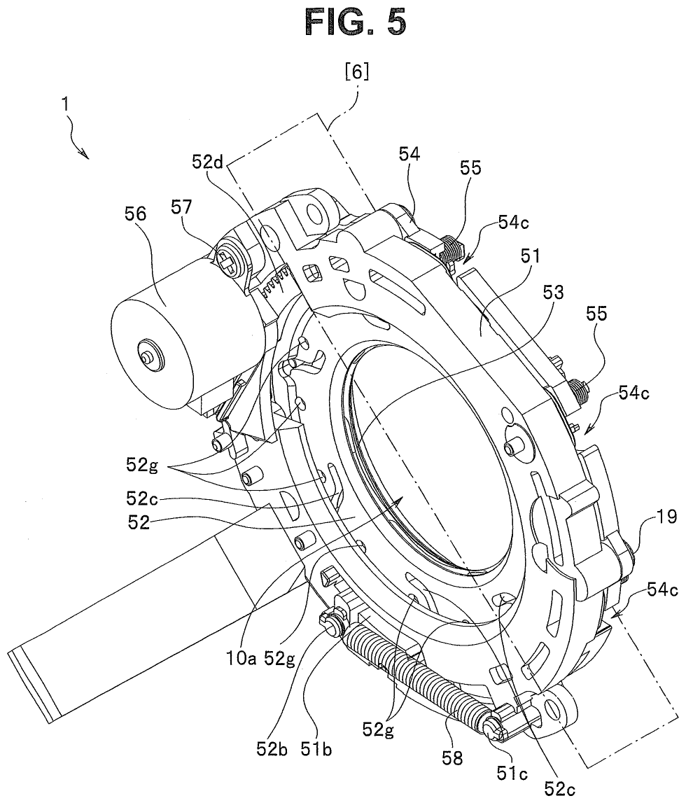

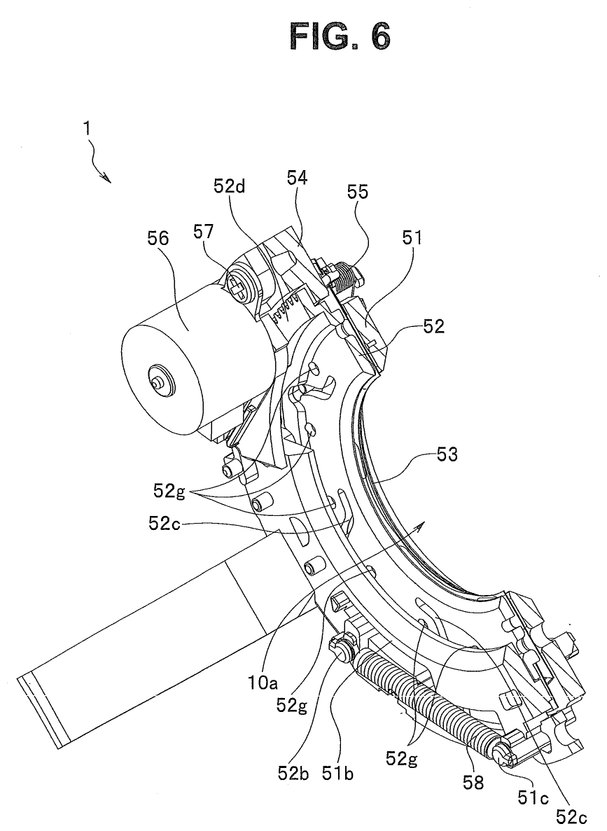

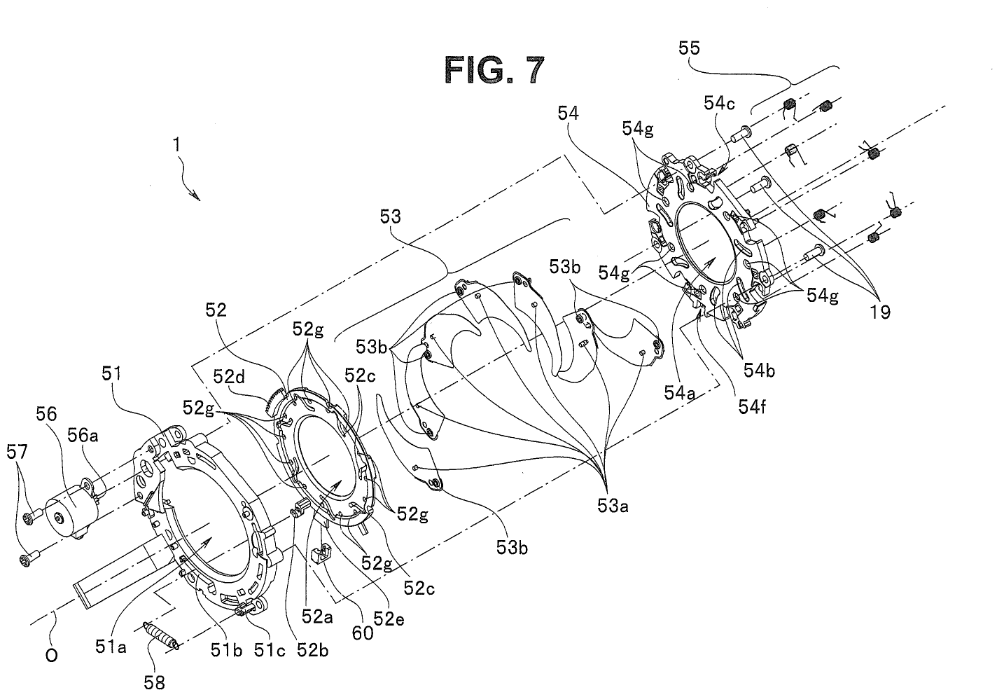

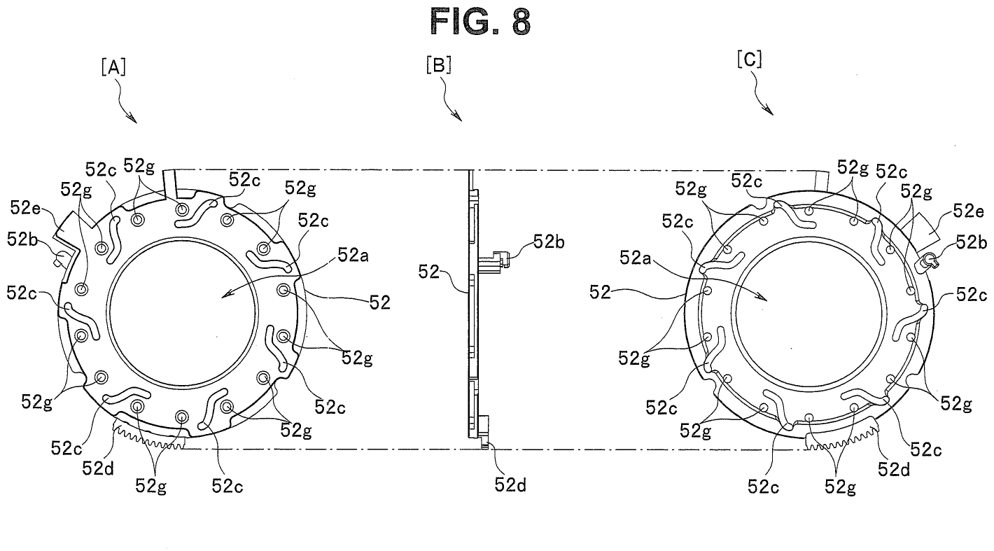

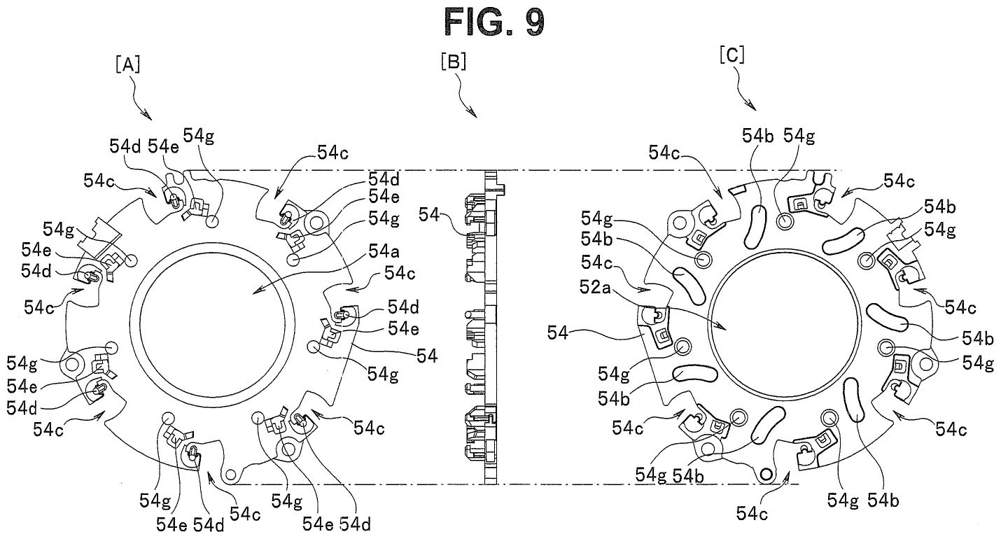

A detailed configuration of the light amount adjusting device 1 is explained below with reference to FIGS. 5 to 9. FIG. 5 is an exterior perspective view of the light amount adjusting device. FIG. 6 is a diagram showing a cut surface cut along a plane indicated by a sign [6] in the exterior perspective view of FIG. 5. FIG. 7 is an exploded perspective view of the light amount adjusting device. FIG. 8 is a trihedral figure of a vane driving member in the light amount adjusting device. FIG. 9 is a trihedral figure of a lid member in the light amount adjusting device. Note that in FIGS. 8 and 9, a sign [A] indicates a front view, a sign [B] indicates a side view, and a sign [C] indicates a rear view.

The light amount adjusting device 1 includes an aperture mechanism unit configured mainly from a mechanical component section and a driving motor 56, which is an electrical component section, functioning as a driving source for driving the aperture mechanism unit.

The light amount adjusting device 1 includes an opening 10a through which a light beam passes. The light amount adjusting device 1 includes a plurality of vane members 53 (explained blow in detail) for forming a desired opening. The plurality of vane members 53 are provided rotatably around an axis parallel to the optical axis O of the light beam passing through the opening 10a in an outer circumferential region of the opening 10a. That is, the light amount adjusting device 1 (the aperture unit) is a component unit disposed in a predetermined position of the internal space of the lens barrel 10 and configured to rotate the plurality of vane members 53 in a predetermined range to form the predetermined opening 10a.

The driving motor 56 is configured to be capable of causing the plurality of vane members 53 to advance and retract in a direction orthogonal to the optical axis O with respect to the opening 10a by driving the plurality of vane members 53 at predetermined timing. Consequently, the light amount adjusting device 1 is a mechanism configured to change and determine a bore diameter of the opening (hereinafter referred to as opening diameter) for the light beam passing along the optical axis O.

Note that the driving motor 56 is controlled to be driven by a control circuit (not shown in FIGS. 5 to 9) provided in an apparatus to which the light amount adjusting device 1 is applied, for example, the lens barrel 10 or an inside of a body of the image pickup apparatus (not shown in FIGS. 5 to 9) to which the lens barrel 10 is attached. The control circuit is configured by a control circuit including, for example, an ASIC (application specific integrated circuit).

The light amount adjusting device 1 is configured mainly by a fixed barrel member 51, a vane driving member 52, the plurality of vane members 53, a lid member 54, torsion springs 55, an urging spring 58 functioning as urging means, a position sensor 60, and the like.

The fixed barrel member 51 is a basic component member in the light amount adjusting device 1. The fixed barrel member 51 is formed in a substantially annular shape as a whole. The fixed barrel member 51 includes a substantially circular opening 51a in a substantially center part of the fixed barrel member 51. The fixed barrel member 51 includes a plurality of supporting shaft sections (not shown in FIGS. 5 to 9) configured to respectively rotatably support the plurality of vane members 53. The plurality of vane members 53 are disposed rotatably around the respective supporting shaft sections (not shown in FIGS. 5 to 9) in a periphery of the opening 51a. The plurality of vane members 53 are configured to be capable of forming a desired opening diameter by respectively rotating (a detailed configuration is explained below). Therefore, the fixed barrel member 51 functions as a supporting member configured to rotatably support the respective plurality of vane members 53.

The fixed barrel member 51 is formed by an annular plane section having the opening 51a, an outer wall section formed to surround an outer circumferential edge of the annular plane section, and an inner wall section formed to surround an inner circumferential edge of the annular plane section, that is, along an outer circumferential edge of the opening 51a. The fixed barrel member 51 formed from such a configuration includes an internal space section in a region on an inner side formed by the annular plane section, the outer wall section, and the inner wall section and forms an annular housing of a form opened on a surface facing the annular plane section.

The vane driving member 52 and the plurality of vane members 53 are housed in the internal space section of the fixed barrel member 51 in a predetermined form (details are explained below). A part of the fixed barrel member 51 facing the annular plane section is opened as explained above. The lid member 54 is disposed to cover the opened part. Consequently, the fixed barrel member 51 and the lid member 54 form an exterior housing of the light amount adjusting device 1. The vane driving member 52 and the plurality of vane members 53 are housed in a predetermined form on an inner side of the exterior housing.

On one side surface of the annular plane section of the fixed barrel member 51, that is, an outer surface side on an opposite side of a side where the internal space section is formed, the driving motor 56 is fixed to the fixed barrel member 51 and disposed in a predetermined part by a plurality of (in the present embodiment, two) screws 57.

As the driving motor 56, for example, a stepping motor is applied. The driving motor 56 is an electric actuator and is an electric driving source for driving to rotate the vane driving member 52 in the light amount adjusting device 1 in a predetermined rotating direction by a predetermined amount at predetermined timing.

The driving motor 56 includes a rotating driving shaft. A pinion gear 56a (see FIG. 7) is fixed at a distal end of the driving shaft. The pinion gear 56a is in mesh with a sector gear 52d (explained below) of the vane driving member 52. With such a configuration, a rotational driving force of the driving motor 56 is transmitted to the vane driving member 52 via the driving shaft, the pinion gear 56a, and the sector gear 52d. Receiving the rotational driving force of the driving motor 56, the vane driving member 52 is driven to rotate by a predetermined amount in a predetermined direction around the optical axis O.

The vane driving member 52 is a component member provided to receive a driving force of the driving motor 56 and drive the plurality of vane members 53. The vane driving member 52 is a member provided rotatably around a center axis of the opening 51a and rotated by a mechanism explained below to thereby determine an opening diameter by the plurality of vane members 53.

The vane driving member 52 is formed in a substantially annular shape slightly smaller in a diameter than the fixed barrel member 51 as a whole. The vane driving member 52 has a substantially circular opening 52a in a substantially center part of the vane driving member 52. A center axis of the opening 52a is disposed to substantially coincide with the center axis of the opening 51a and the optical axis O. The vane driving member 52 is disposed regularly and reversely rotatable within a predetermined range in a radial direction around the optical axis O with respect to the fixed barrel member 51 in the internal space section of the fixed barrel member 51.

The sector gear 52d is formed in a part of an outer periphery portion of the vane driving member 52. As explained above, the pinion gear 56a of the driving motor 56 is in mesh with the sector gear 52d. Consequently, the rotational driving force of the driving motor 56 is transmitted to the vane driving member 52 and rotates the vane driving member 52 around the optical axis O.

A first spring locking section 52b configured to lock one end of the urging spring 58 is formed in a part near the outer periphery portion of the vane driving member 52. The first spring locking section 52b is an axial part formed to project toward a direction substantially orthogonal to a radial direction of the vane driving member 52 (a direction parallel to the optical axis O). One end of the urging spring 58 is locked to the first spring locking section 52b. Therefore, a distal end portion of the first spring locking section 52b is formed in a shape for locking one end of the urging spring 58 to prevent the urging spring 58 from easily coming off, for example, in a substantial hook shape.

The urging spring 58 is an urging member for urging to rotate the vane driving member 52 in one direction around the optical axis O with respect to the fixed barrel member 51 and urging to rotate the plurality of vane members 53 in one direction around a rotation axis parallel to the optical axis O. The urging spring 58 is formed by, for example, a taut coil spring.

On the other hand, a through-groove 51b having a predetermined length along the circumferential direction is formed in a predetermined part in the annular plane section of the fixed barrel member 51. The through-groove 51b is formed to, when the vane driving member 52 is housed in a predetermined part of the internal space section of the fixed barrel member 51, cause the first spring locking section 52b to pierce through the through-groove 51b and dispose the first spring locking section 52b to project to the outer surface side of the fixed barrel member 51 (one side surface of the annular plane section). That is, the first spring locking section 52b is configured to move along the through-groove 51b when the vane driving member 52 receives the driving force of the driving motor 56 and rotates.

On the other hand, a second spring locking section 51c projected toward the same direction as the first spring locking section 52b is formed near the through-groove 51b on the outer surface side of the fixed barrel member 51 (the one side surface side of the annular plane section). The other end of the urging spring 58 is locked to the second spring locking section 51c. Therefore, a distal end portion of the second spring locking section 51c is forming in a shape for locking the other end of the urging spring 58 to prevent the urging spring 58 from easily coming off, for example, in a substantial hook shape.

As explained above, one end of the urging spring 58 is locked to the first spring locking section 52b of the vane driving member 52. The other end of the urging spring 58 is locked to the second spring locking section 51c of the fixed barrel member 51. Therefore, with this configuration, the vane driving member 52 is always urged in one rotating direction with respect to the fixed barrel member 51 by the urging force of the urging spring 58. In this case, the rotation urging direction of the vane driving member 52 by the urging spring 58 is, for example, a direction (a closing direction) in which the plurality of vane members 53 driven by the rotation of the vane driving member 52 narrow the opening diameter.

Note that separately from this configuration example, the urging direction of the vane driving member 52 by the urging spring 58 may be set in a direction (an opening direction) for expanding the opening diameter.

A plurality of cam grooves 52c having a cam curve formed in a predetermined shape are formed in a plane part forming an annular shape in the vane driving member 52. Respective driven pins 53a (engaging pins) of the plurality of vane members 53 are respectively engaged in the plurality of cam grooves 52c. With this configuration, when the vane driving member 52 receives the driving force of the driving motor 56 and rotates around the optical axis O, the plurality of cam grooves 52c move in the radial direction around the optical axis O in the same manner according to the rotation. Consequently, the respective driven pins 53a of the plurality of vane members 53 relatively move along the respective cam grooves 52c. Therefore, the plurality of vane members 53 are driven to rotate around the supporting shaft sections.

In this way, the plurality of cam grooves 52c are parts functioning as driving sections configured to respectively drive the plurality of vane members 53. The plurality of cam grooves 52c as many as the plurality of vane members 53 are formed corresponding to the plurality of vane members 53. In the present embodiment, an example is explained in which seven vane members 53 are disposed (see FIG. 7). Seven cam grooves 52c of the vane driving member 52 in the present embodiment are formed corresponding to the seven vane members 53.

The plurality of cam grooves 52c are provided in the vane driving member 52. The driven pins 53a are provided in the plurality of vane members 53. The driven pins 53a are engaged in the cam grooves 52c. Cam means is formed by the cam grooves 52c and the driven pins 53a.

Note that in the present embodiment, a configuration example is explained in which the cam grooves 52c are provided in the vane driving member 52 and the driven pins 53a are provided in the vane members 53. However, a configuration of the cam means is not limited to the configuration example. For example, cam grooves may be provided on a vane member side and driven pins may be provided on a vane driving member side.

Further, a plurality of through-holes 52g are provided in the vane driving member 52. The plurality of through-holes 52g are hole sections piercing through the vane driving member 52 in a direction substantially orthogonal to an annular plane of the vane driving member 52 (the direction parallel to the optical axis O). The plurality of through-holes 52g are disposed over substantially an entire circumference of the vane driving member 52 side by side in the circumferential direction at a predetermined interval near the outer periphery portion of the vane driving member 52 (see FIG. 8). The plurality of through-holes 52g are through-holes formed in the light amount adjusting device 1 (the aperture unit) and communicating with the internal space.

In this case, regions where the plurality of through-holes 52g are disposed are desirably present near positions facing the plurality of vane members 53 when the light amount adjusting device 1 is in an assembled state and the plurality of vane members 53 are in an opened state. Therefore, in the present embodiment, the plurality of through-holes 52g are disposed near the outer periphery portion of the vane driving member 52.

The plurality of vane members 53 are disposed to be superimposed one on top of another in an outer circumferential region of the openings 51a and 52a. With this configuration, the plurality of vane members 53 are variable opening forming members for forming a substantially circular opening and respectively performing predetermined movement (rotation around the supporting shaft sections parallel to the optical axis O) to thereby change a diameter of the opening and perform adjustment of an amount of light passing through the opening.

Each of the plurality of vane members 53 is formed by, for example, a thin plate-like sheet member. The respective vane members 53 are formed in, for example, a substantially lunate shape. The driven pins 53a configured to engage in the cam grooves 52c of the vane driving member 52, through-holes 53b, through which the supporting shaft sections (not shown in FIGS. 5 to 9) of the fixed barrel member 51 are disposed to pierce, the through-holes 53b functioning as rotation centers, vane-side torsion-spring locking sections (not shown in FIGS. 5 to 9) configured to lock the other arm sections of the torsion springs 55, and the like are formed near proximal end portions of the respective vane members 53.

The driven pins 53a are shaft members configured to engage in the cam grooves 52c of the vane driving member 52 and drive the respective vane members 53 according to rotation of the vane driving member 52. The supporting shaft sections (not shown in FIGS. 5 to 9) of the fixed barrel member 51 are disposed to pierce through the through-holes 53b. Consequently, the through-holes 53b function as the rotation centers of the vane members 53. As explained below, the vane side torsion spring looking sections (not shown in FIGS. 5 to 9) are parts configured to receive an urging force of the torsion springs 55 for urging the respective vane members 53 in predetermined one direction.

The through-holes 53b are formed near the proximal end portions of the vane members 53. On the internal space section side in the annular plane section of the fixed barrel member 51, a plurality of supporting shaft sections (not shown in FIGS. 5 to 9) configured to respectively support the plurality of vane members 53 to be capable of rotating around the through-holes 53b are provided corresponding to the through-holes 53b by the same number (in the present embodiment, seven) as the plurality of vane members 53.

The plurality of supporting shaft sections are implanted to respectively project from the annular plane section of the fixed barrel member 51 toward an inside of the internal space section (toward a side on which the plurality of vane members 53 are disposed) in the direction parallel to the optical axis O. The respective supporting sections are disposed side by side at substantially equal intervals in the circumferential direction of the annular plane section of the fixed barrel member 51.

When the light amount adjusting device 1 is assembled, the supporting shaft sections are respectively disposed to pierce through the respective through-holes 53b of the plurality of vane members 53. Consequently, the plurality of vane members 53 are housed in the internal space section of the fixed barrel member 51 in a state in which the plurality of vane members 53 are axially supported rotatably around rotation axes (i.e., the supporting sections) parallel to the optical axis O. In this state, the respective driven pins 53a of the plurality of vane members 53 are respectively engaged in the plurality of cam grooves 52c of the vane driving member 52.

In the internal space of the fixed barrel member 51, in a state in which the vane driving member 52 and the plurality of vane members 53 are housed in predetermined forms in predetermined positions, the lid member 54 is disposed in an opening part facing the annular plane section of the fixed barrel member 51.

That is, the opening part of the fixed barrel member 51 is covered by the lid member 54 when the light amount adjusting device 1 is assembled. The fixed barrel member 51 and the lid member 54 are fastened and fixed by, for example, a plurality of screws 19.

The lid member 54 is formed in a substantially annular shape having substantially the same diameter as the fixed barrel member 51. The lid member 54 includes a circular opening 54a in a substantially center part of the lid member 54. A center axis of the circular opening 54a is disposed to substantially coincide with the center axes of the openings 51a and 52a and the optical axis O.

The lid member 54 has a function of a member for covering the opening part of the fixed barrel member 51 and preventing the respective component members (the vane driving member 52, the plurality of vane members 53, and the like) housed in the internal space of the fixed barrel member 51 from coming off.

Projecting sections (not shown in FIGS. 5 to 9) on back sides of the respective driven pins 53a of the plurality of vane members 53 respectively engage with an inner surface side (a surface facing the internal space of the fixed barrel member 51) of the lid member 54. Bottomed grooves 54b for guiding rotation of the respective vane members 53 are formed.

A plurality (the same number as the number of the vane members 53) of cutout sections 54c for respectively exposing the through-holes 53b functioning as the rotation centers near the proximal end portions of the respective vane members 53 housed in the internal space of the fixed barrel member 51 are formed.

Further, a plurality of through-holes 54g are provided in the lid member 54. The plurality of through-holes 54g are hole sections piercing through the lid member 54 in a direction substantially orthogonal to an annular plane section of the lid member 54 (the direction parallel to the optical axis O). The plurality of through-holes 54g are disposed side by side over a substantially entire circumference in the circumferential direction at a predetermined interval near a substantially middle position in the radial direction in the plane section of the lid member 54 (see FIG. 9). The plurality of through-holes 54g are through-holes formed in the light amount adjusting device 1 (the aperture unit) and communicating with the internal space.

In this case, regions where the plurality of through-holes 54g are disposed are desirably present in positions facing the plurality of vane members 53 in a state in which the light amount adjusting device 1 is assembled and when the plurality of vane members 53 are in the opened state. Therefore, in the present embodiment, the plurality of through-holes 54g are disposed near the substantially middle position of the lid member 54.

Furthermore, the plurality of through-holes 54g are disposed alternately with the bottomed grooves 54b side by side on a substantially same diameter circle on which the bottomed grooves 54b are disposed. As explained above, the bottomed grooves 54b are disposed in positions facing the projecting sections (not shown in FIGS. 5 to 9) on the back sides of the driven pins 53a of the plurality of vane members 53. Therefore, if the plurality of through-holes 54g are provided on the substantially same diameter circle on which the bottomed grooves 54b are disposed, the through-holes 54g are inevitably disposed in the positions facing the plurality of vane members 53 in the opened state.

The torsion springs 55 are urging members for always urging to rotate the respective plurality of vane members 53 in one direction to thereby contract or open the opening forming by the plurality of vane members 53. In the present embodiment, an urging force by the torsion springs 55 is set to urge the respective vane members 53 in a closing direction.

The torsion springs 55 are urging members that use an urging force in a torsion direction. That is, the torsion springs 55 include main body sections wound in a coil shape, one arm sections extending from one ends of the main body sections, and the other arm sections similarly extending from the other ends of the main body sections.

The main body sections of the torsion springs 55 are disposed to be inserted through torsion spring insert-through sections 54d (see FIG. 9) of the lid member 54. The one arm sections of the torsion springs 55 are locked to torsion-spring locking sections 54e (see FIG. 9) of the lid member 54. The other arm sections of the torsion springs 55 are locked to vane-side torsion-spring locking sections (not shown in FIG. 9).

One torsion spring 55 is provided corresponding to each of the plurality of vane members 53. Therefore, in the present embodiment, seven torsion springs 55 are disposed corresponding to the seven vane members 53.

The position sensor 60 is provided to detect a position in a rotating direction of the vane driving member 52. As the position sensor 60, for example, a photointerrupter is applied. The position sensor 60 is disposed in a position-sensor disposing section 54f formed in a concave shape in a predetermined part on an inside of a housing formed by combining the fixed barrel member 51 and the lid member 54. The position sensor 60 is fixed to the housing using means such as bonding.

Corresponding to the position sensor 60, a light-blocking vane section 52e acting on the position sensor 60 is formed at an outer periphery portion of the vane driving member 52. The light-blocking vane section 52e passes between light transmitting and light receiving sections of the position sensor 60 to detect a position in the rotating direction of the vane driving member 52.

The light amount adjusting device 1 configured in this way is attached to a predetermined position on the inside of the lens barrel 10. The attachment of the light amount adjusting device 1 to the lens barrel 10 is briefly explained below.

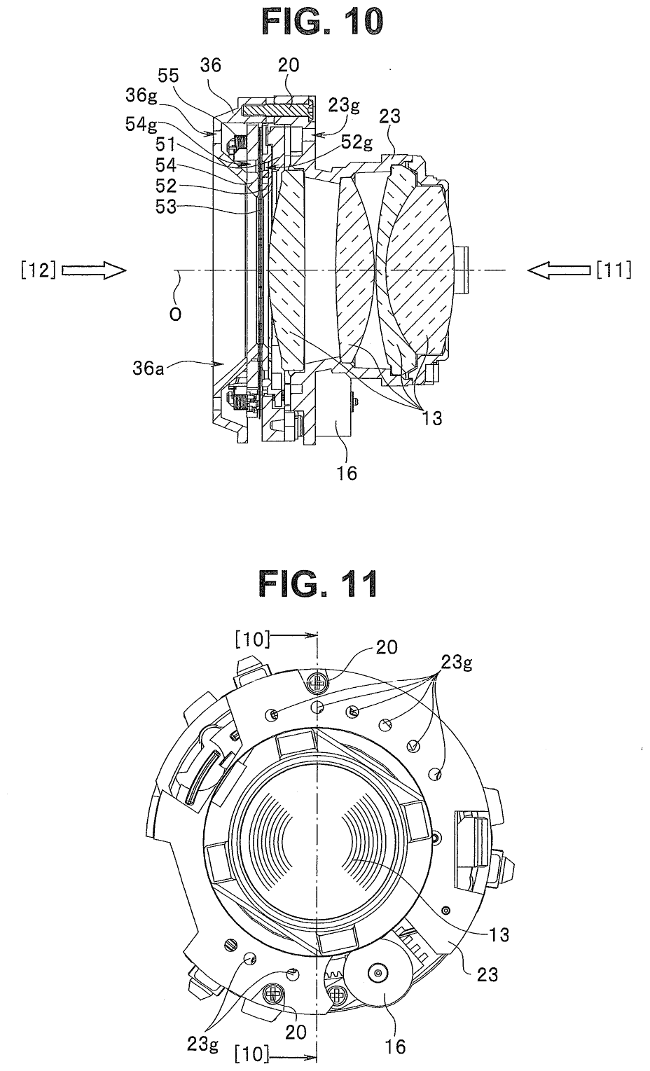

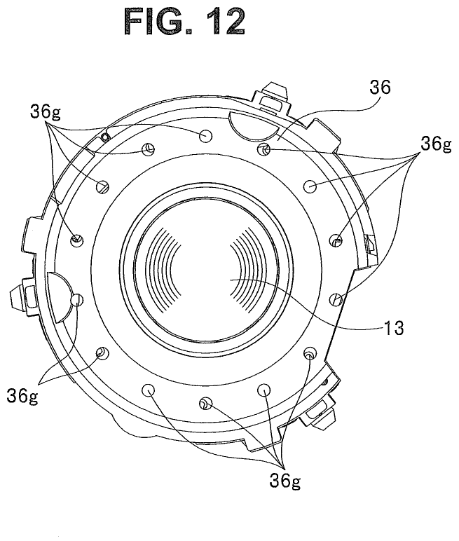

FIG. 10 is a sectional view showing a state in which the light amount adjusting device is assembled to the third lens group holding cylinder. Note that FIG. 10 shows a cross section taken along a [10]-[10] line in FIG. 11. FIG. 11 is a plan view (a rear view) viewed from an arrow [11] direction in FIG. 10. FIG. 12 is a plan view (a front view) viewed from an arrow [12] direction in FIG. 10.

The light amount adjusting device 1 is assembled to a front surface side of the third lens group holding cylinder 23 of the lens barrel 10 to be integrated with the third lens group holding cylinder 23. Therefore, a front cover member 36 having an opening 36a around the optical axis O and having an annular shape as a whole is provided on the front surface side of the third lens group holding cylinder 23. An annular plane section close to an outer circumference of the front cover member 36 is formed to cover a part of the front surface of the light amount adjusting device 1 and project toward the front surface side. With this shape, the front cover member 36 has an internal space having a predetermined volume. Various component members (e.g., the torsion springs 55) disposed to project from the light amount adjusting device 1 toward the front surface among components of the light amount adjusting device 1 are housed in the internal space. Consequently, front surfaces of the component members are covered. A plurality of through-holes 36g are formed in the front cover member 36. In the present embodiment, an example is explained in which the plurality of through-holes 36g are formed in a front projecting section in the front cover member 36.

As shown in FIG. 12, the plurality of through-holes 36g are disposed over a substantially entire circumference side by side in the circumferential direction at a predetermined interval. In this case, regions where the plurality of through-holes 36g are disposed are provided in parts that can communicate with the through-holes 54g on a surface of the light amount adjusting device 1 facing the plurality of through-holes 54g in a state in which the light amount adjusting device 1 is attached to the third lens group holding cylinder 23.

As shown in FIG. 11, the front cover member 36 is fixed to the front surface side of the third lens group holding cylinder 23 using a plurality of (in this example, two) screws 20 or the like. In this case, the light amount adjusting device 1 is fixed in a state in which the light amount adjusting device 1 is held between the front cover member 36 and the third lens group holding cylinder 23.

On the other hand, a plurality of through-holes 23g are formed in the third lens group holding cylinder 23. As shown in FIG. 11, the plurality of through-holes 23g are disposed side by side in the circumferential direction at a predetermined interval in predetermined regions (in this example, two regions) close to an outer circumference of the third lens group holding cylinder 23. In this case, regions where the plurality of through-holes 23g are disposed are provided in parts that can communicate with the through-holes 52g on a surface of the light amount adjusting device 1 facing the plurality of through-holes 52g in a state in which the light amount adjusting device 1 is attached to the third lens group holding cylinder 23.

The lens barrel 10 to which the light amount adjusting device 1 is attached is mounted on a predetermined position of the image pickup apparatus (not shown in FIGS. 10 to 12). That is, when an image pickup operation is executed using the image pickup apparatus, photographing parameters (shutter speed, an aperture value, and the like) are set according to a photographing environment. In a setting operation for the aperture value included in the photographing parameters, the light amount adjusting device 1 is controlled. The diameter of the opening formed by the plurality of vane members 53 changes at predetermined timing as appropriate. Consequently, the light amount adjusting device 1 can perform light amount adjustment of a light beam passing through the image pickup optical system of the lens barrel 10 and reaching a light receiving surface of an image pickup device (not shown in FIGS. 10 to 12) of the image pickup apparatus.

In this case, the plurality of vane members 53 slide with one another every time the light amount adjusting device 1 is driven. The plurality of vane members 53 are charged with one another because of the sliding. Static electricity of the charging continues to accumulate without being discharged forever if nothing is performed.

Incidentally, when the image pickup apparatus (not shown in FIGS. 10 to 12) mounted with the lens barrel 10 applied with the light amount adjusting device 1 is used, zooming operation is performed as appropriate. The zooming operation is executed by the user performing manual operation for rotating the zoom ring 42.

For example, the state shown in FIG. 1 indicates a state in which the movable cylinder 26 is contracted most in the lens barrel 10. When the lens barrel 10 is in the state shown in FIG. 1 and rotation operation in a predetermined rotating direction around the optical axis O of the zoom ring 42 is performed by the user, as explained above, the movable cylinder 26 moves in an extending direction in the direction along the optical axis O according to action of a not-shown zoom mechanism. At the same time, the third lens group holding cylinder 23, in which the light amount adjusting device 1 (the aperture unit) is integrally provided, also moves in the direction along the optical axis O. The lens barrel 10 changes to, for example, a state shown in FIG. 3 soon. The state shown in FIG. 3 indicates a state in which the movable cylinder 26 is extended most in the lens barrel 10.

When the lens barrel 10 is displaced from the state shown in FIG. 1 to the extended state (e.g., the state shown in FIG. 3) in this way and at least one of the first optical unit (the first lens group 11, the first lens group holding cylinder 21, and the movable cylinder 26) and the light amount adjusting device 1 (the aperture unit) moves in the direction of the optical axis O, an internal space region (a region indicated by a sign R in FIG. 3) of the movable cylinder 26 has a negative pressure. The internal space region R communicates with the external space through an air flow route indicated by an arrow FL in FIGS. 1 and 3.

In detail, the air flow route FL in the lens barrel 10 refers to a path communicating with an air flow path (the gaps G1 and G2 and the hole sections 30a (see FIGS. 1 and 3)), which connect the external space and the internal space, the air circulating in the air flow route FL in the internal space. The air flow route FL refers to a path including the through-holes 23g, 52g, 54g, and 36g (see FIGS. 2 and 4) and reaching from a gap G3, which communicates with the hole sections 30a of the air flow path, to the internal space region R. Therefore, the through-holes 23g, 52g, 54g, and 36g are disposed in the internal space.

That is, the air sucked from the external space into the inside of the lens barrel 10 passes in the air flow route FL through the air flow path and is sucked into the internal space region R. At this time, the air sucked from the plurality of through-holes 23g into an inside of the third lens group holding cylinder 23 is blown against the plurality of vane members 53 from the plurality of through-holes 52g in the light amount adjusting device 1. The air comes out to the plurality of through-holes 54g through gaps among overlapping vanes of the plurality of vane members 53. At this time, electricity of the plurality of vane members 53 is removed. That is, the air flowing in the air flow route FL is charged by coming into contact with the plurality of vane members 53 in a charged state. The charged air passes in the air flow route FL, whereby the electricity of the plurality of vane members 53 is removed.

Note that as a configuration for enabling the air to circulate among the overlapping vanes of the plurality of vane members 53, for example, the plurality of vane members 53 are disposed in a state in which planes of the respective vanes of the plurality of vane members 53 are inclined with respect to the optical axis O. With such a configuration, the air flowing from through-holes provided in parts facing the plurality of vane members 53 is blown against the planes of the respective vanes and thereafter flows along the planes of the respective vanes. The air flowing along the planes of the respective vanes in this way easily enters even slight gaps among the respective vanes. Therefore, the circulation of the air is more smoothly performed.

In this way, the air blown toward the plurality of vane members 53 from the plurality of through-holes 52g is ionized and comes out to the plurality of through-holes 54g. Thereafter, the air reaches the internal space region R, whereby the negative pressure in the internal space region R is changed to a positive pressure.

On the other hand, when the movable cylinder 26 of the lens barrel 10 is in a state in which the movable cylinder 26 is more extended than in the state shown in FIG. 1 (e.g., a state of FIG. 3 is shown as an example of a state in which the movable cylinder 26 is extended to a maximum) and the user performs the rotation operation in the predetermined rotating direction around the optical axis O of the zoom ring 42 and performs operation for returning the movable cylinder 26 to the state shown in FIG. 1, similarly, the movable cylinder 26 is contracted in the direction along the optical axis O by action of the not-shown zoom mechanism. The movable cylinder 26 changes to, for example, the state shown in FIG. 1 soon.

When the lens barrel 10 is displaced from the extended state (e.g., the state shown in FIG. 3) to the state shown in FIG. 1 in this way, the internal space region (the region indicated by the sign R in FIG. 3) of the movable cylinder 26 shifts to the positive pressure.

That is, when the movable cylinder 26 moves in the contracting direction, at least one of the first optical unit (the first lens group 11, the first lens group holding cylinder 21, and the movable cylinder 26) and the light amount adjusting device 1 (the aperture unit) moves in the optical axis O direction. The air in the internal space region R passes in the air flow route FL and is discharged to the external space from the air flow path (the hole sections 30a and the gaps G2 and G1). A path of the discharge of the air is the same as a path during suction of the air. The electricity of the plurality of vane members 53 is also removed when the air is discharged from the internal space region R to the external space through the air flow route FL and the air flow path (the hole sections 30a and the gaps G2 and G1).

As explained above, the light amount adjusting device 1 according to the embodiment includes, in the lens barrel 10 in which the air flow path (the gaps G1 and G2 and the hole sections 30a) for causing the external space and the internal space to communicate is formed, the aperture unit 1 disposed in the internal space and configured to rotate the plurality of vane members 53 in the predetermined range to form the predetermined opening 10a, the optical unit (12 and 22) disposed in the internal space and located on the object side with respect to the aperture unit, and the through-holes 52g and 54g formed in the aperture unit and communicating with the internal space. When at least one of the optical unit and the aperture unit moves in the optical axis O direction, the air in the internal space is brought into contact with the plurality of vane members via the air flow path and the through-holes to charge the air. The charged air is discharged to the external space.

With such a configuration, in the light amount adjusting device 1, when the movable cylinder 26 (a movable member) moves in the direction along the optical axis O according to rotation operation of the zoom ring 42, the air convects in the air flow route FL. At this time, the convecting air passes through the plurality of through-holes 52g and 54g. The air is blown against the region where the plurality of vane members 53 overlap and passes among the overlapping vane members 53. Consequently, electricity of the plurality of vane members 53 in the light amount adjusting device 1 can be removed.

In this way, in the light amount adjusting device 1, the plurality of through-holes 52g and 54g are disposed and configured in the positions coinciding with the air flow route FL. It is possible to remove electricity of the plurality of vane members 53 of the light amount adjusting device 1 using convection of the air caused by normal zoom operation. Therefore, it is possible to perform electricity removal of the light amount adjusting device 1 only by performing normal use without executing special operation. Therefore, static electricity is not excessively accumulated while electricity of (the plurality of vane members 53 of) the charged light amount adjusting device 1 is not discharged.

Note that in the example explained in the embodiment, the user manually performs the zooming operation of the zoom ring 42. However, the zooming operation is not limited to such operation means. For example, a configuration may be adopted in which the user performs pressing operation or slide operation of a zoom switch, whereby an electric zoom mechanism acts and the same zooming operation is performed. Even in such zooming operation, in a form in which zooming can be realized by moving a predetermined lens barrel member in the optical axis direction, it is possible to obtain completely the same effects as the effects in the embodiment.

In the embodiment, as the lens barrel applied with the light amount adjusting device 1, the lens interchangeable lens barrel, that is, the zoom lens barrel configured such that the entire lens barrel moves in the direction along the optical axis according to the magnification operation (the zooming operation) is illustrated. However, the lens barrel is not limited to this configuration example.

For example, the configuration of the present invention can also be applied to a lens barrel including a focus adjusting mechanism configured such that an optical system in a part of an image pickup optical system can be movable in the direction along the optical axis according to focus adjusting operation (focusing operation). Even in the case, the same effects can be obtained.

For example, the configuration of the present invention can also be applied to a lens barrel including a mechanism for moving an optical system in a part of an image pickup optical system in a predetermined direction with respect to the optical axis (a so-called image stabilization mechanism).

That is, the same effects can be obtained if a lens barrel includes a movable member on an inside, can perform suction and discharge of air between an outside and the inside of the lens barrel, includes an air flow path for convecting taken-in air on the lens barrel inside, and can be configured to dispose a plurality of vane members on a route of the air flow path.

In the present embodiment, the configuration is illustrated in which the cam grooves 52c are provided in the vane driving member 52 and the driven pins 53a are provided in the plurality of vane members 53. However, the lens barrel is not limited to this configuration. For example, the lens barrel can also be configured by providing cam grooves on a plurality of vane members side and, on the other hand, providing driven pins on a vane driving ring side. In that case, completely the same action and effects can be obtained.

The present invention is not limited to the embodiment explained above. It goes without saying that various modifications and applications can be carried out within a range not departing from the gist of the invention. Further, inventions in various stages are included in the embodiment. Various inventions can be extracted by appropriate combinations of a disclosed plurality of constituent elements. For example, when the problems to be solved by the invention can be solved and the effects of the invention can be obtained even if several constituent elements are deleted from all the constituent elements explained in the embodiment, a configuration in which the constituent elements are deleted can be extracted as an invention. Further, the constituent elements explained in different embodiments may be combined as appropriate. The present invention is not limited by specific modes of implementation of the invention except being limited by the appended claims.

What is claimed is:

1. A lens barrel in which an air flow path that causes an external space and an internal space to communicate is formed, the lens barrel comprising:
an aperture unit disposed in the internal space and configured to rotate a plurality of vane members within a predetermined range to form a predetermined opening;
an optical unit disposed in the internal space and located on an object side with respect to the aperture unit; and
at least one through-hole formed in the aperture unit and communicating with the internal space, wherein
when at least one of the optical unit and the aperture unit moves in an optical axis direction, the lens barrel discharges, through the air flow path and the through-hole, air in the internal space and static electricity charged in the plurality of vane members included in the air in the internal space.

2. The lens barrel according to claim 1, wherein the aperture unit includes:
a vane driving member disposed rotatably around a center axis of the opening and configured to drive the plurality of vane members; and
a fixed barrel member including a supporting shaft section configured to rotatably axially support the plurality of vane members, the fixed barrel member housing inside the plurality of vane members and the vane driving member.

3. The lens barrel according to claim 1, wherein a plurality of the through-holes are provided, the plurality of through-holes being formed in parts facing the plurality of vane members disposed in a state in which the plurality of vane members overlap one another and are charged.

4. The lens barrel according to claim 1, wherein a plurality of the through-holes are provided, the plurality of through-holes being bored in parts facing the plurality of vane members when an opening formed by the plurality of vane members is set to a maximum opening diameter.

5. The lens barrel according to claim 3, wherein charged air is discharged to the external space passing among the plurality of vane members disposed in a state in which the plurality of vane members overlap one another and are charged.
